(19) United States
(12) Patent Application Publication
(10) Pub. No.: US 2022/0262258 A1
(43) Pub. Date: Aug. 18, 2022

(54) AN AVIONIC COMPUTER ARCHITECTURE

(71) Applicant: TUSAS-TURK HAVACILIK VE UZAY SANAYII ANONIM SIRKETI, Ankara (TR)

(72) Inventors: Mehmet Cemil KAZANBAS, Kahramankazan, Ankara (TR); Mehmet Fatih SAYARLAR, Kahramankazan, Ankara (TR)

(73) Assignee: TUSAS- TURK HAVACILIK VE UZAY SANAYII ANONIM SIRKETI, Ankara (TR)

(21) Appl. No.: 17/625,051

(22) PCT Filed: Aug. 24, 2020
(86) PCT No.: PCT/TR2020/050742

§ 371 Date: Jan. 5, 2022

(30) Foreign Application Priority Data
Aug. 28, 2019 (TR) 2019/13054

(51) Int. Cl. G08G 5/00; G06T 1/20; G06T 1/60

(52) U.S. Cl. CPC G08G 5/003; G06T 1/60; G06T 1/20

(57) ABSTRACT

At least one processing unit is provided in air and/or space vehicles and enables the avionic systems of air and/or space vehicles to be controlled and managed is disclosed. At least one sensing unit enables the data used in the execution of the flight control algorithm to be received from the physical environment, at least one application unit enables the instructions transmitted by the processing unit to be performed, at least one programmable hardware unit is provided in association with the sensing unit and the application unit, and enables the data received from the sensing unit to be processed and enables the air vehicle control instructions to be transmitted to the application unit, and at least one volatile memory unit that is provided in association with the processing unit is capable of exchanging data with the processing unit and enables the data processed by the processing unit to be stored.

The present invention relates to an architecture structure for computers in air and/or space vehicles, which is used to manage and control the avionic systems of the air and/or space vehicles.

Various electronic equipment and systems are used in air and/or space vehicles for communication, navigation, display, registration, and control. Such electronic equipment and systems, so-called avionic systems, operate in association with each other in order to perform multiple individual functions as required in air vehicles. In order to monitor and control said avionic systems, flight control computers are used.

Chinese Patent Application no. CN108594841 discloses that a central processing unit uses the data that are received from the sensors and the control unit by the programmable hardware and processed, and executes the flight control algorithm. Said system comprises an electrical connection between the programmable hardware and the central processing unit, and a communication channel in which direct data transfer is carried out. However, the central processing unit cannot be used in an efficient manner, and it is not easy to add and remove hardware.

Another patent document No. discloses a tamper-resistant geo-fence system for drones. In an embodiment of this document, said system is in the form of a computer system, within which a set or sequence of instructions may be executed. Said system comprises at least one processor, a main memory and a static memory, which communicate with each other via a link. Said system further comprises a video display, an alphanumeric input device, a UI navigation device, a storage device and a signal generating device.

In the known state of art, the central processing unit (CPU) is alone responsible for the management of the flight control computers in the air and/or space vehicles and regular operation of the associated hardware, and these functions result in excessive power consumption, high heat production, etc. In said avionic architectures, since the central processing unit should have direct access to each hardware, such functions as access, data collection, generation of instructions are performed individually in a hardware-specific manner, resulting in a great deal of time loss. Since the operating systems in the current technology are not capable of performing parallel processes, a single operation may be performed at one time, and the processing unit is forced to compensate the time lost in accessing different hardware programs with a high operation and interface speed. The increased operation and interface speeds in turn increase the power consumed by the processor, the amount of heat that is generated and accordingly the need to use cooling equipment and fans.

In the known state of art, the central processing unit (CPU) carries all the low-level interface software required to directly access all external hardware. Therefore, the software of the real-time operating system (RTOS) should be changed in possible hardware amendments, which requires the renewal of the software certificate of the entire operating system, thereby resulting in prolongation of the certification process.

In the known state of art, in the flight control computers provided in air and/or space vehicles, at the start-up of a computer or in the event of a failure of a host computer, a hand shaking procedure is performed by the operating system at the time of activation of the back-up computer so as to individually control whether all pieces of hardware are working properly.

In air and/or space vehicles, operations of generating graphics and images to be displayed on various indicators and display screens provided in front of the pilots in the cockpit layout in the state-of-art, writing text on videos, applying a sliding map, etc. are performed by a graphics processing unit (GPU).

In the known state of art, the field programmable gate arrays (FPGA), the programmable logic blocks, and the integrated circuits which are composed of interconnections between the blocks and which may be replaced, upon manufacture thereof, depending on the intended function to be performed by the hardware structure, are used.

Thanks to the avionic computer architecture according to the present invention, a fast, effective, efficient, and reliable avionic computer architecture is obtained.

An object of the present invention is to provide an avionic computer architecture which reduces the dependency of the avionic architectures on the software programs of the real-time operating system in the central processing unit.

The avionic computer architecture realized to achieve the object of the invention and defined in the first claim and the claims dependent thereon comprises at least one processing unit which enables the electronic systems provided in the air and/or space vehicles to be controlled, monitored and managed, at least one sensing unit which enables the data required for the execution of the flight control algorithm to be received from the physical environment and to be rendered processable by the programmable hardware, thereby enabling data input from the external environment, at least one application unit which performs instructions transmitted by the processing unit and/or enables data output from the system to the external environment, at least one programmable hardware unit which is provided in association with the sensing unit and the application unit, and enables the data received from the sensing unit to be processed and enables the air vehicle control instructions to be transmitted to the application unit, and at least one volatile memory unit which is provided in association with the processing unit, is capable of exchanging data with the processing unit, enables the data processed by the processing unit to be stored, and allows the data which will be used to execute the flight control algorithm to be stored in a manner to be accessed by the processing unit.

The avionic computer architecture according to the invention comprises a volatile memory unit which is capable of performing bidirectional data exchange with the programmable hardware unit, stores the data registered thereon by the programmable hardware unit, and allows the processing unit to access the data stored therein, and transmits the instructions registered thereon by the processing unit to the programmable hardware unit.

In an embodiment of the invention, the avionic computer architecture comprises at least one hardware- and/or software-based intermediate layer which enables data exchange between the volatile memory unit, the processing unit, and the programmable hardware unit.

In an embodiment of the invention, the avionic computer architecture comprises at least one graphics processing unit operating in data exchange with the volatile memory unit, and generating graphics, images and tables using the data received from the volatile memory unit.

In an embodiment of the invention, the avionic computer architecture comprises a certified sensing unit including a modular, certified software, which is controlled by the programmable hardware unit and which may be inserted and removed and/or replaced to perform different functions.

In an embodiment of the invention, the avionic computer architecture comprises a certified application unit including a modular, certified software, which is controlled by the programmable hardware unit and which may be inserted and removed and/or replaced to perform different functions.

In an embodiment of the invention, the avionic computer architecture comprises a processing unit controlled and/or monitored by the programmable hardware unit.

In an embodiment of the invention, the avionic computer architecture comprises a graphics processing unit controlled and/or monitored by the programmable hardware unit.

In an embodiment of the invention, the avionic computer architecture comprises a programmable hardware unit including partial certified software programs, which enables data exchange between the sensing unit and the application unit, and which makes particular part of the software to be affected by a change implemented in the detection and/or application units.

In an embodiment of the invention, the avionic computer architecture comprises a programmable hardware unit having the volatile memory unit integrated in its board structure.

In an embodiment of the invention, the avionic computer architecture comprises a programmable hardware unit providing designing and generating some of the graphics, tables, and symbols.

In an embodiment of the invention, the avionic computer architecture comprises a processing unit having interface hardware and software programs which enable the data registered by the programmable hardware unit to be received and/or used through the data exchange with the volatile memory unit.

In an embodiment of the invention, the avionic computer architecture comprises a programmable hardware unit having interface hardware and software programs which enable the data transmitted by the processing unit and/or the graphics processing unit to be received and/or used through the data exchange with the volatile memory unit.

In an embodiment of the invention, the avionic computer architecture comprises a programmable hardware unit consisting of a FPGA (Field Programmable Gate Array) type integrated circuit member.

In an embodiment of the invention, the avionic computer architecture comprises an intermediate layer including a FPGA type semi-conductor hardware.

In an embodiment of the invention, the avionic computer architecture comprises a volatile memory unit being a DDR4 type memory.

The avionic computer architecture realized to achieve the object of the present invention is illustrated in the attached drawings, in which:

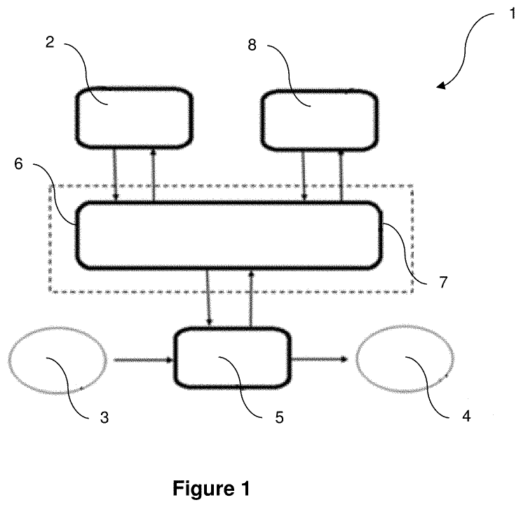

FIG. 1 is a block diagram of an avionic computer architecture.

All the parts in the figures are individually assigned a reference numeral and the corresponding terms of these numbers are listed as follows:
1. Avionic Computer Architecture
2. Processing Unit
3. Sensing unit
4. Application Unit
5. Programmable Hardware Unit
6. Volatile Memory Unit
7. Intermediate Layer
8. Graphics Processing Unit

The avionic computer architecture (1) comprises at least one processing unit (2) which is provided in air and/or space vehicles and enables the avionic systems of air and/or space vehicles to be controlled and managed, at least one sensing unit (3) which enables the data used in the execution of the flight control algorithm to be received from the physical environment, at least one application unit (4) which enables the instructions transmitted by the processing unit (2) to be performed, at least one programmable hardware unit (5) which is provided in association with the sensing unit (3) and the application unit (4), and enables the data received from the sensing unit (3) to be processed and enables the air vehicle control instructions to be transmitted to the application unit (4), and at least one volatile memory unit (6) which is provided in association with the processing unit (2), is capable of exchanging data with the processing unit (2), and enables the data processed by the processing unit (2) to be stored (FIG. 1).

The avionic computer architecture (1) according to the invention comprises a volatile memory unit (6) which is capable of performing data exchange with the programmable hardware unit (5), stores the data processed by the programmable hardware unit (5), and allows the processing unit (2) to access same.

The avionic computer architecture (1) has a processing unit (2) consisting of a CPU (Central Processing Unit). The processing unit (2) processes the data received from the sensing unit (3) by means of mathematical operations and transmits the result to the application unit (4), thereby ensuring the generation of the necessary output. The air vehicle avionic computer architecture (1) includes a sensing unit (3) which enables data input to allow communication with the external environment, and an application unit (4) which enables an output to be generated according to the data processed and/or enables the air vehicle to generate a physical response and/or output in the external environment. The programmable hardware unit (5) manages the data exchange traffic between the sensing unit (3) and the application unit (4) and the air vehicle. The programmable hardware unit (5) ensures that the data received by means of the sensing unit (3) are stored in the volatile memory unit (6) to be transmitted to the processing unit (2). The processing unit (3) ensures that the instructions generated are stored in the volatile memory unit (6) to be transmitted to the application unit (4).

The I/O management of the sensing unit (3) and the application unit (4) is controlled by the programmable hardware unit (5). If a sensing unit (3) and an application unit (4) is added and/or removed, the software of the programmable hardware unit (5) is just amended so as to adapt the avionic computer architecture (1) to the hardware amendments. The programmable hardware unit (5) performs the action of receiving and processing the physical data converted into electrical signals by the sensing units (3) and storing them into the volatile memory unit (6). The data stored in the volatile memory unit (6) are received by the processing unit (2) and used to perform various flight applications. The flight control instructions outputted by the processing unit (2) are stored into the volatile memory unit (6) to be transmitted to the application unit (4) by the programmable hardware unit (5). Thus, the volatile memory unit (6) is effectively controlled by the programmable hardware unit (5) and the processing unit (2) is efficiently used (FIG. 1).

In an embodiment of the invention, the avionic computer architecture (1) comprises at least one hardware- and/or software-based intermediate layer (7) which enables data exchange of the volatile memory unit (6) with the processing unit (2) and the programmable hardware unit (5). The volatile memory unit (6) that is in communication with the processing unit (2) by means of the intermediate layer (7) is allowed to communicate with the programmable hardware unit (5). The data exchange of the volatile memory unit (6) with other units is performed by intermediate layer (7). The intermediate layer (7) comprises software programs for connection between the programmable hardware unit (5) and the processing unit (2).

In an embodiment of the invention, the avionic computer architecture (1) comprises at least one graphics processing unit (8) which is capable of performing data exchange with the volatile memory unit (6), and enables graphics and images to be generated. The graphics processing unit (8) performs a bidirectional data exchange with the volatile memory unit (6) in order to receive and process the data stored by the programmable hardware unit (5) into the volatile memory unit (6). The graphics processing unit (8) performs the actions of generating different warnings, graphics and images to be displayed to the user by the application unit (4) consisting of display screen and indicators, writing text on videos, applying a sliding map, etc., and stores the necessary instructions into the volatile memory unit (6) to be transmitted to the application unit (4) by the programmable hardware unit (5).

In an embodiment of the invention, the avionic computer architecture (1) comprises a sensing unit (3) having a hardware and software certificate, which is controlled by the programmable hardware unit (5) and is removed or attached according to the needs of the user. The sensing unit (3) is provided in association with the programmable hardware unit (5), allowing data input from the external environment and transmitting the received data to the programmable hardware unit (5). The sensing unit (3) has hardware and software certificates, wherein in case a sensing unit (3) is inserted or removed based on the needs of the user, no amendment is needed in relation with the certificates. If a new sensing unit (3) without a certificate is inserted, a hardware and software certificate is obtained just for that sensing unit (3), and the equipment is integrated into the system.

In an embodiment of the invention, the avionic computer architecture (1) comprises an application unit (4) having a hardware and software certificate, which is controlled by the programmable hardware unit (5), and is attached or removed according to the needs of the user. The application unit (4) is provided in association with the programmable hardware unit (5), allowing the data received from the programmable hardware unit (5) to generate a physical response and/or output in the external environment. The application unit (4) has hardware and software certificates, wherein in case an application unit (4) is inserted or removed based on the needs of the user, no amendment is needed in relation with the certificates. If a new application unit (4) without a certificate is inserted, a hardware and software certificate is obtained just for that application unit (4) which is then integrated into the system.

In an embodiment of the invention, the avionic computer architecture (1) comprises a processing unit (2) controlled and monitored by the programmable hardware unit (5). The processing unit (2) uses the data processed by the programmable hardware unit (5) and stored into the volatile memory unit (6). The communication of the processing unit (2) with the sensing unit (3) and the application unit (4), and data exchange thereof is controlled by the programmable hardware unit (5).

In an embodiment of the invention, the avionic computer architecture (1) comprises a graphics processing unit (8) controlled and monitored by the programmable hardware unit (5). The graphics processing unit (8) uses the data processed by the programmable hardware unit (5) and stored into the volatile memory unit (6). The communication of the graphics processing unit (2) with the sensing unit (3) and the application unit (4), and data exchange thereof is controlled by the programmable hardware unit (5).

In an embodiment of the invention, the avionic computer architecture (1) comprises a programmable hardware unit (5) enabling data exchange between the sensing unit (3) and the application unit (4), and comprising software programs for the sensing unit (3) and the application unit (4) each having an independent certificate. The software programs and protocols to be used by the programmable hardware unit (5) to exchange data with the sensing unit (3) and the application unit (4) are comprised in the programmable hardware unit (5), as divided into independent sections for each sensing unit (3) and the application unit (4) and certified. In this manner, if a new sensing unit (3) and/or application unit (4) is inserted, it is sufficient for the software of the programmable hardware unit (5) to obtain a software certificate just for the unit inserted.

In an embodiment of the invention, the avionic computer architecture (1) comprises a programmable hardware unit (5) having the volatile memory unit (6) embedded thereon. The volatile memory unit (6) may be provided as an independent hardware or may be composed of a volatile memory unit (6) embedded on a programmable hardware unit (5). A memory provided on the programmable hardware unit (5) may be used as the volatile memory unit (6) and may perform the same function as the volatile memory unit (6) being an external hardware.

In an embodiment of the invention, the avionic computer architecture (1) comprises a programmable hardware unit (5) which enables the graphics and images to be generated. The programmable hardware unit (5) may be used to perform basic operations such as generating graphics, writing text on images, etc. In this manner, the task load of the graphics processing unit (8) is reduced and the heating thereof may be avoided.

In an embodiment of the invention, avionic computer architecture (1) comprises a processing unit (2) comprising interface hardware and software programs which enable data exchange with the programmable hardware unit (5) by means of the volatile memory unit (6). The interface software programs ensure that the processing unit (2) exchanges data with the volatile memory unit (6) in order to receive and use the data stored by the programmable hardware unit (5) into the volatile memory unit (6).

In an embodiment of the invention, the avionic computer architecture (1) comprises a programmable hardware unit (5) comprising interface hardware and software programs which enable data exchange with the processing unit (2) and the graphics processing unit (8) by means of the volatile memory unit (6). The interface software programs ensure that the programmable hardware unit (5) exchanges data with the volatile memory unit (6) in order to ensure that the data stored by the processing unit (2) into the volatile memory unit (6) are received and used by the programmable hardware unit (5).

In an embodiment of the invention, the avionic computer architecture (1) comprises a programmable hardware unit (5) consisting of a FPGA type integrated circuit. Thanks to its parallel processing capability, the programmable hardware unit (5) consisting of a FPGA type integrated circuit may perform multiple processes at one time, and the data is enabled to be transmitted to the respective unit in a fast and accurate manner.

In an embodiment of the invention, the avionic computer architecture (1) comprises an intermediate layer (7) which comprises a FPGA type integrated circuit. The intermediate layer (7) monitors and regulates the data exchange performed by means of the volatile memory unit (6) without a direct electrical connection and/or a communication channel between the programmable hardware unit (5) and the processing unit (2). With the intermediate layer (7) comprising a FPGA type integrated circuit, the data exchange from the volatile memory unit (6) is carried out in a faster and more reliable manner.

In an embodiment of the invention, the avionic computer architecture (1) comprises a volatile memory unit (6) being a DDR4 type memory. In this manner, high bandwidth and performance is achieved and power consumption is reduced.

1. An avionic computer architecture comprising at least one processing unit (2) which is provided in air and/or space vehicles and enables the avionic systems of air and/or space vehicles to be controlled and managed, at least one sensing unit (3) which enables the data used in the execution of the flight control algorithm to be received from the physical environment, at least one application unit (4) which enables the instructions transmitted by the processing unit (2) to be performed, at least one programmable hardware unit (5) which is provided in association with the sensing unit (3) and the application unit (4), and enables the data received from the sensing unit (3) to be processed and enables the air vehicle control instructions to be transmitted to the application unit (4), and at least one volatile memory unit (6) which is provided in association with the processing unit (2), is capable of exchanging data with the processing unit (2), and enables the data processed by the processing unit (2) to be stored, characterized by a volatile memory unit (6) which is capable of exchanging data with the programmable hardware unit (5), stores the data processed by the programmable hardware unit (5), and allows the processing unit (2) to access them, wherein said programmable hardware unit (5) is adapted to change its software if said sensing unit (3) and said application unit (4) is added and/or removed so as to adapt the avionic computer architecture (1) to the hardware amendments.

2. An avionic computer architecture (1) according to claim 1, characterized by at least one hardware- and/or software-based intermediate layer (7) which enables data exchange of the volatile memory unit (6) with the processing unit (2) and the programmable hardware unit (5).

3. An avionic computer architecture (1) according to claim 1, characterized by at least one graphics processing unit (8) which is capable of performing data exchange with the volatile memory unit (6), and enables graphics and images to be generated.

4. An avionic computer architecture (1) according to claim 1, characterized by a sensing unit (3) having a certified hardware and software, which is controlled by the programmable hardware unit (5) and which is adapted to be attached or removed based on the needs of the user.

5. An avionic computer architecture (1) according to claim 1, characterized by an application unit (4) having a certified hardware and software, which is controlled by the programmable hardware unit (5) and which is adapted to be attached or removed based on the needs of the user.

6. An avionic computer architecture (1) according to claim 1, characterized by the processing unit (2) which is controlled and monitored by the programmable hardware unit (5).

7. An avionic computer architecture (1) according to claim 3, characterized by the graphics processing unit (8) which is controlled and monitored by the programmable hardware unit (5).

8. An avionic computer architecture (1) according to claim 1, characterized by the programmable hardware unit (5) enabling data exchange between the sensing unit (3) and the application unit (4), and comprising software programs for the sensing unit (3) and the application unit (4) each having an independent certificate.

9. An avionic computer architecture (1) according to claim 1, characterized by the programmable hardware unit (5) having the volatile memory unit (6) embedded thereon.

10. An avionic computer architecture (1) according to claim 1, characterized by the programmable hardware unit (5) which enables graphics and images to be generated.

11. An avionic computer architecture (1) according to claim 1, characterized by the processing unit (2) comprising interface hardware and software programs which enable data exchange with the programmable hardware unit (5) by means of the volatile memory unit (6).

12. An avionic computer architecture (1) according to claim 3, characterized by the programmable hardware unit (5) comprising interface hardware and software programs which enable data exchange with the processing unit (2) and the graphics processing unit (8) by means of the volatile memory unit (6).

13. An avionic computer architecture (1) according to claim 1, characterized by the programmable hardware unit (5) consisting of a FPGA type integrated circuit.

14. An avionic computer architecture (1) according to claim 2, characterized by an intermediate layer (7) comprising a FPGA type integrated circuit.

15. An avionic computer architecture (1) according to claim 1, characterized by the volatile memory unit (6) being a DDR4 type memory.
